(19) United States
(12) Patent Application Publication
(10) Pub. No.: US 2014/0297044 A1
(43) Pub. Date: Oct. 2, 2014

(54) Acoustic-Pulser Feedback and Power Factor Control of a HIFU Device

(71) Applicant: Mirabilis Medica, Inc., Bothell, WA (US)

(72) Inventors: Gregory P. Darlington, Snohomish, WA (US); Tim Etchells, Seattle, WA (US)

(73) Assignee: Mirabilis Medica, Inc., Bothell, WA (US)

(21) Appl. No.: 14/217,360

(22) Filed: Mar. 17, 2014

Related U.S. Application Data
(60) Provisional application No. 61/799,589, filed on Mar. 15, 2013.

(51) Int. Cl. G05D 19/02

(52) U.S. Cl. CPC G05D 19/02
USPC 700/280

(57) ABSTRACT

A method and system for adjusting a HIFU device compensates for shifts in transducer impedance so that the acoustic output from a HIFU transducer remains at a desired level. In accordance with a first aspect, the disclosure includes dynamically adjusting the tuning of a tuning network that causes the transducer/system to maintain an optimal power transfer to the acoustic output. In accordance with a second aspect, the disclosure monitors the acoustic output of the HIFU device and adjusts the electrical signal provided to the HIFU transducer to maintain a desired acoustic output.

### CROSS-REFERENCE TO RELATED APPLICATION

This application claims the benefit of U.S. Provisional Patent Application No. 61/799,589, filed Mar. 15, 2013, the disclosure of which is incorporated by reference herein in its entirety.

### BACKGROUND

The power levels output by a high intensity focused ultrasound (HIFU) device can cause a shift in the impedance of the transducer of the HIFU device and/or a shift in the transfer characteristics of the electrical power output stage (pulser) of the HIFU device.

Ceramic transducers are predominantly capacitive and are typically tuned to appear resistive at a resonant frequency that allows the energy transfer to be maximized. Tuning of transducers normally takes place in a factory during device manufacturing, utilizing low voltage measurement techniques to measure transducer impedance. The impedance of the piezoceramic used for ultrasound transducers can be highly temperature and voltage dependent. In addition, ceramic transducers can change or degrade over time, causing shifts in impedance during use.

### SUMMARY

The following summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure recognizes a determined need to dynamically adjust HIFU devices to compensate for shifts in transducer impedance so that the acoustic output remains at an intended level. A first aspect of the disclosure dynamically adjusts the tuning of the transducer/system to maintain optimal power transfer. A second aspect of the disclosure monitors the acoustic output of the device and adjusts the device electrical output to maintain a constant acoustic output.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a typical transducer impedance plot;

FIG. 2 illustrates a preferred embodiment of a block diagram for controlling transducer tuning;

FIG. 3 illustrates a transducer tuning control feedback with sensors at an output of a power amplifier;

FIG. 4 illustrates a transducer tuning control with acoustic feedback;

FIG. 5A illustrates a typical passive transducer tuning circuit;

FIG. 5B illustrates an enhanced tuning circuit with variable capacitance;

FIG. 5C illustrates an enhanced tuning circuit with both variable inductance and variable capacitance;

FIG. 5D illustrates an enhanced tuning circuit adding a series capacitance variable;

FIG. 6 illustrates a feed forward configuration for controlling transducer tuning;

FIG. 7 illustrates a block diagram for acoustic feedback with digital processing;

FIG. 8 illustrates a block diagram for acoustic feedback with analog processing;

FIG. 9A illustrates an acoustic receiver laminated to the front of a HIFU bowl transducer;

FIG. 9B illustrates an acoustic receiver laminated to the back of a HIFU bowl transducer as shown in FIG. 9A;

FIG. 9C illustrates a flat acoustic receiver transducer offset in front of a HIFU bowl transducer as shown in FIG. 9A;

FIG. 9D illustrates a flat acoustic receiver transducer offset from the back of a HIFU bowl transducer as shown in FIG. 9A;

FIG. 9E illustrates small element receiver transducers on the front surface of a HIFU bowl transducer as shown in FIG. 9A;

FIG. 9F illustrates small element receiver transducers offset in front of a HIFU bowl transducer as shown in FIG. 9A;

FIG. 9G illustrates small element receiver transducers on the back surface of a HIFU bowl transducer as shown in FIG. 9A; and

FIG. 9H illustrates small element receiver transducers that are offset from the back surface of a HIFU bowl transducer as shown in FIG. 9A.

### DETAILED DESCRIPTION

In a first aspect, the following specification describes an automatic impedance compensation method and mechanism to auto tune and track the resonance of a transducer in real time and thereby allow a HIFU device to adapt to variances in transducer impedance.

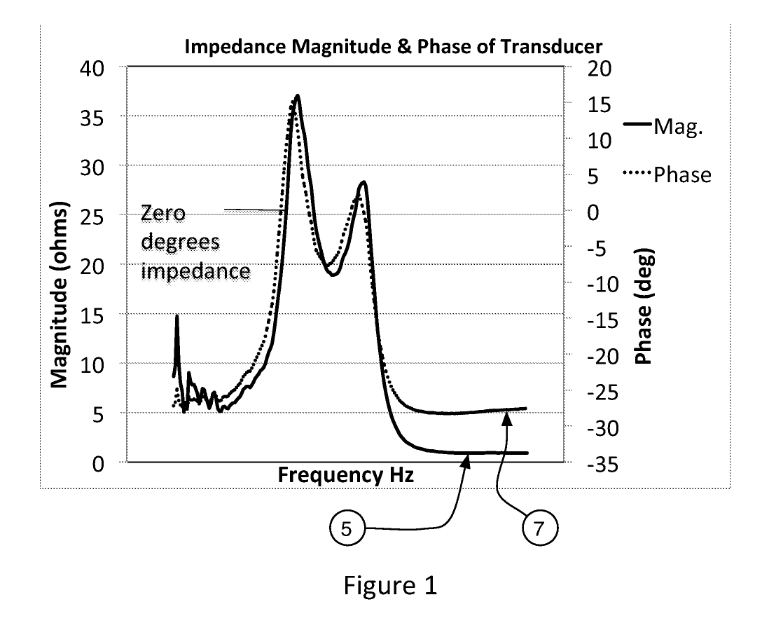

FIG. 1 shows a typical transducer impedance plot exhibiting both impedance 5 and phase 7. As indicated, the slope of the curve is fairly steep at the frequency of interest, so a slight shift in characteristics can cause a large shift in impedance.

By monitoring the impedance or either the instantaneous or average voltage and current, in either the time or frequency domain, the optimum impedance can be calculated or iterated towards. In various embodiments, impedance compensation is achieved by varying the elements of an impedance network residing between the transmitter and the ceramic transducer of the HIFU device. With impedance compensation, the phase difference can be minimized and power transfer maximized via the following equation:

P=V*I*cosθ
where

P=electrical power, V=voltage, I=current, and Θ=phase difference between the voltage and current.

Although the equation above is for electrical power (e.g., at the input of the transducer), it can be shown that one can also close the loop by monitoring the waveform of the acoustic output via a secondary acoustic transducer in the acoustic field.

The present disclosure allows a transducer to be kept tuned and achieve a longer useful lifecycle. In addition, it allows a transducer and/or cable to be changed out on a system without requiring the tuning networks in the system to be replaced.

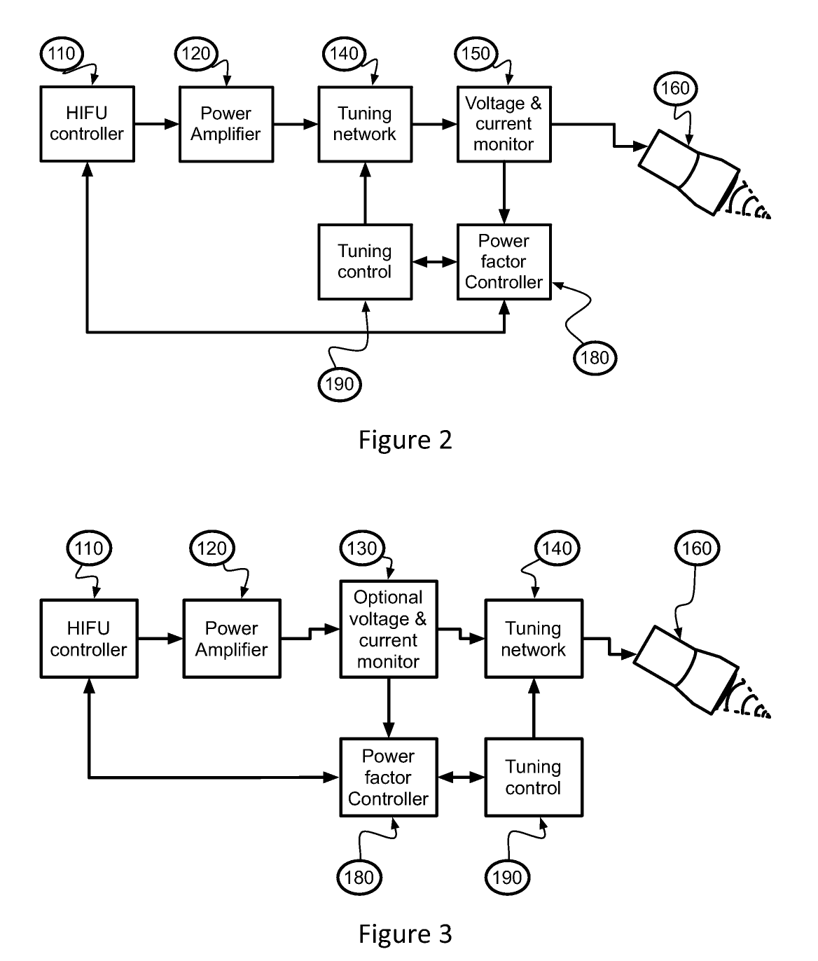

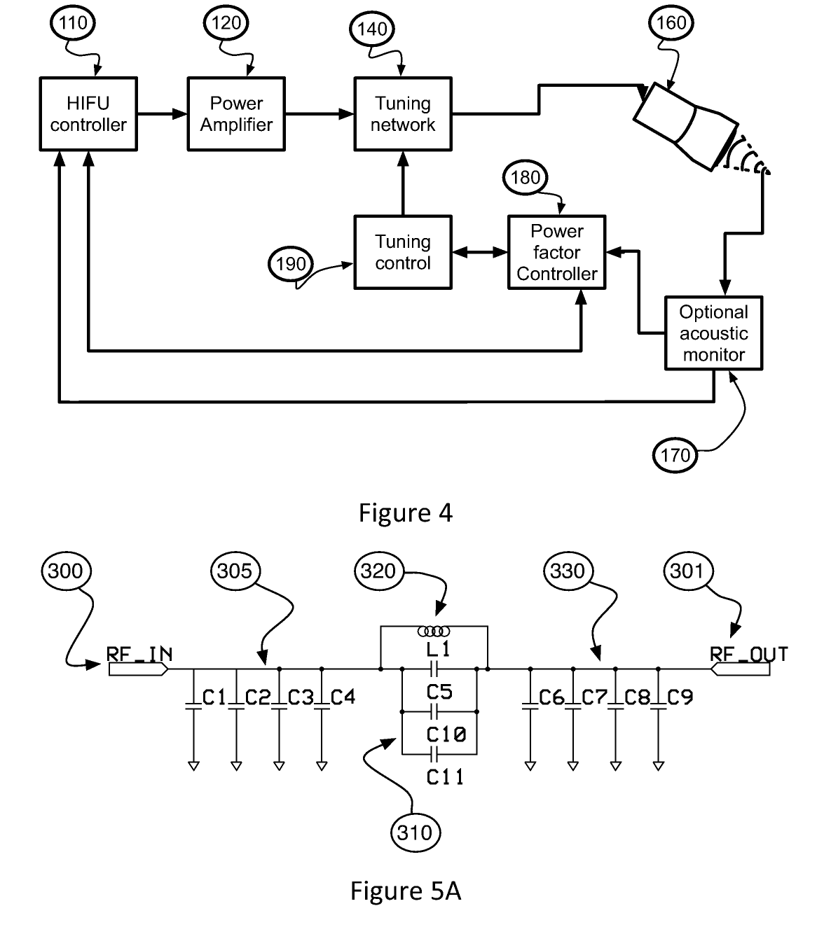

FIG. 2 shows an embodiment of the present disclosure in which voltage and current are monitored at the input of the transducer. A HIFU controller 110 sets output levels and waveform timing of a signal to be used for driving a HIFU transducer 160. As controlled by the HIFU controller 110, a power amplifier 120 generates the waveform for driving the transducer. A tuning network 140 is used for “matching” the impedance of the transducer to the power amplifier 120, as described herein. A voltage and current monitor 150 senses and monitors the output waveform voltage and current. HIFU transducer 160 converts the output electrical waveform (energy) into an acoustic waveform (energy). An optional acoustic monitor 170 (e.g., as shown in FIG. 4) uses an acoustic sensor for detecting and monitoring the acoustic waveform in the acoustic field. A power factor controller 180 receives monitored data and calculates a compensation to improve the impedance matching. Based on the calculated compensation, a tuning control 190 communicates with the tuning network 140 for adjusting tuning component values in the tuning network 140.

FIG. 3 shows an alternate embodiment of the present disclosure in which an optional voltage and current monitor 130 monitors the waveform voltage and current prior to the tuning of the transducer 160 by the tuning network 140.

FIG. 4 shows yet another embodiment of the present disclosure that relies on monitoring of the acoustic waveform for a predetermined optimal characteristic, and then adjusting the tuning of the transducer 160 by the tuning network 140 for optimal acoustic output by the HIFU transducer 160.

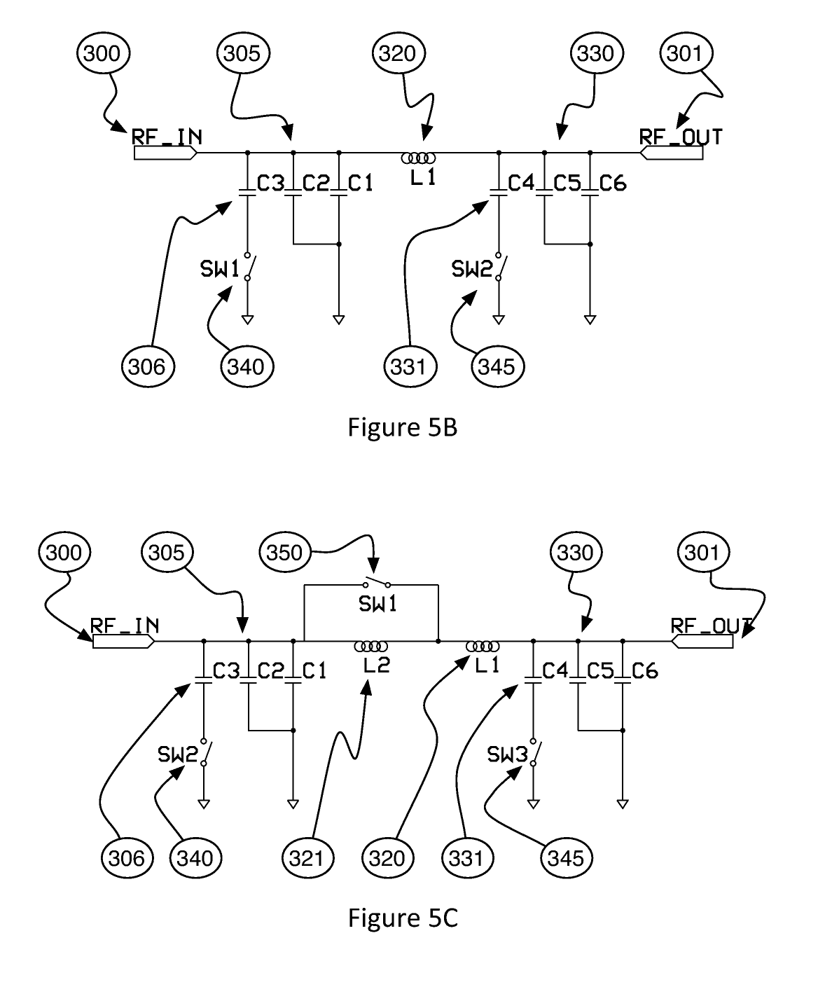

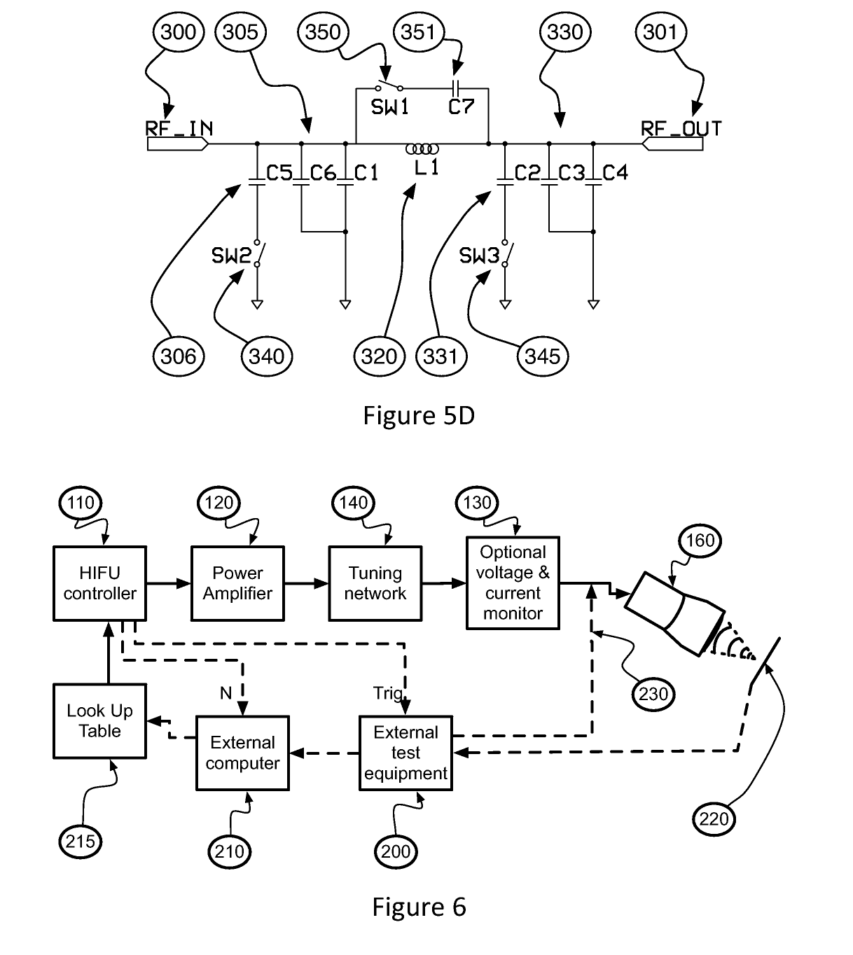

FIG. 5A depicts a tuning network 140 that can be used in any of the foregoing depicted embodiments. The tuning network 140 comprises an LC network with component parts 305, 310, 320, 330. The component parts 305, 310, 320, 330 are designed and values are chosen for the inductor and capacitor elements to tune the overall phase and impedance of the driving waveform to match the load of the transducer 160.

In another embodiment of the tuning network 140 that can be used in any of the embodiments depicted in FIGS. 2-4, the capacitors of the LC network are replaced with varicap diodes. Varicap diodes have the property such that the component capacitance changes in a specified manner with applied voltage. Although this property exists in other diodes, it is an explicitly defined parameter for these devices. This approach is sometimes limited in voltage due to the nature of the parts, so other methods are needed at higher voltages.

In yet another embodiment shown in FIG. 5B, the tuning network 140 may include multiple capacitors with field effect transistors (FET) or pin diodes as switches 340, 345, that are used to vary the effective capacitance 306, 331. In this embodiment, the FET or diode capacitance has to be taken into account.

In cases where the capacitance of the device dominates the capacitance of the capacitor being inserted, a relay could be used to insert the capacitor into the circuit. As would be understood by one skilled in the art, the FET switches 340, 345 could be replaced with many currently available devices, such as bipolar transistors, mechanical relays, pin diodes, etc.

In yet another embodiment shown in FIG. 5C, the inductance presented by the inductive element 320 can be varied using inductor 321 in addition to or instead of varying the capacitance of the tuning network 140. In this embodiment, the inductor 321 has several taps on its core, which are brought out to FETs, relays, diodes, or other switches 350 such that they are connected or disconnected to vary the inductance.

It should be obvious to one skilled in the art that although only one switch 340, 345 is shown on each capacitor node 306, 331 and one switch 350 is shown across the inductor 321, there may be multiple capacitor/switch elements and multiple indictor/switch elements to affect the desired granularity and range of the variable capacitance and inductance of the tuning network 140. In addition, the ground connection need only be an AC ground, which could also include a bias rail or other intermediate voltage.

FIG. 5D illustrates yet another embodiment of an enhanced tuning network 140 adding a series capacitance variable 351. In yet another embodiment, tuning may be accomplished with the use of a transformer (auto, isolation, etc.). In this embodiment, the transformer windings may be “tapped” through the use of the aforementioned variety of switches to effectively vary the winding ratio of the respective transformer.

It should also be noted that one could use a feed forward technique where the transfer function (measured value OUT with respect to both the programmed value IN and TIME) is characterized for a given HIFU device prior to the HIFU device being used for treatment. Current calibration techniques for ultrasound devices are performed at a single time value or averaged over a period of time. This technique generates a time dependent calibration table that is used to compensate for component variation due to heating, power supply droop, etc. The measured OUT value(s) may be measured in either the electrical (voltage and/or current) or acoustic (pressure) domains.

As illustrated in FIG. 6, external test equipment 200 may be used to capture electrical data 230 and/or acoustic data 220. This data is read into an external computer 210 along with a programmed value N from the HIFU controller 110 that is used in connection with a look up table 215 to set the output of the HIFU controller 110. The devices 200, 210, 220 shown with dotted line connections are in place for calibration and are not necessary during runtime. The computer 210 generates a table of values that correlates a desired output level to a programmed value N representing the transfer function of output acoustic power as a function of both the programmed value N and time, and then programs this table into the look up table 215 or into another part of the device/software to be written into the look up table 215 at runtime. The HIFU device uses the time dependent data in the look up table 215 to vary the programmed values of the power amplifier 120 at runtime to compensate for the aforementioned component heating affects, power supply droop, etc. The HIFU device may be characterized on an element-by-element basis or as an aggregate of all channel/transducer elements, with the corresponding compensation applied during runtime.

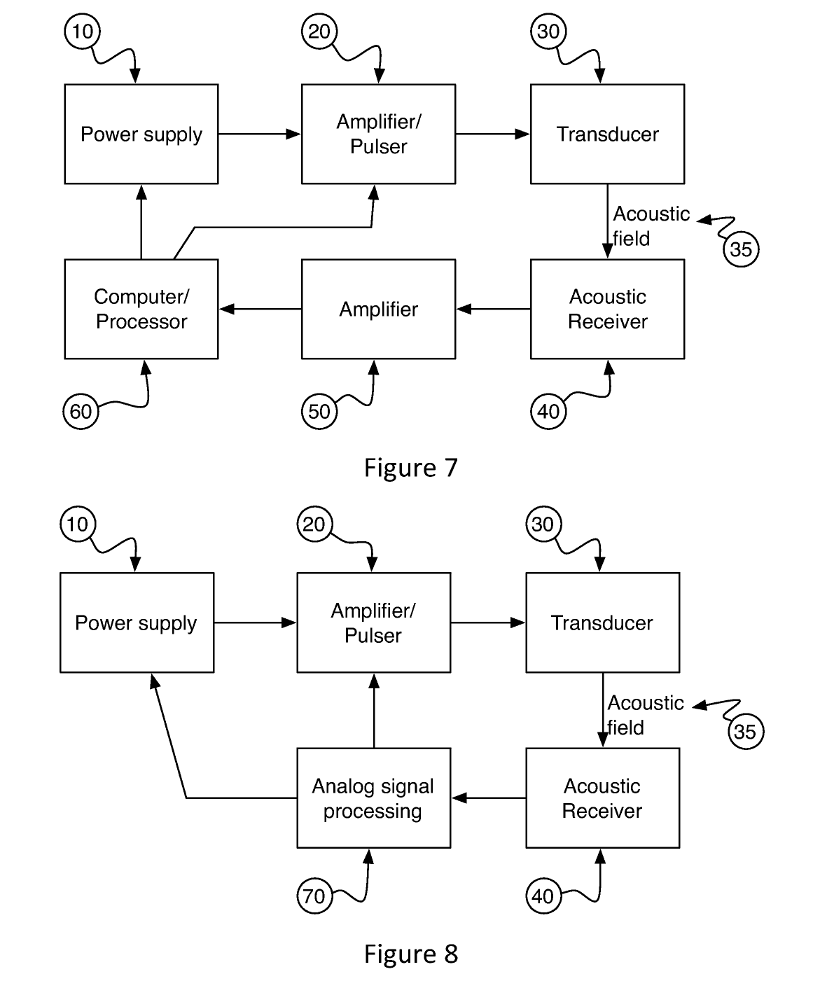

In addition to varying the system tuning (with tuning network 140) to match the impedance of the transducer 160, the HIFU device may use acoustic feedback to close the loop and compensate the amplitude of the power amplifier output for cases where the transducer or system output varies over time. Causes for these variations may be due to normal heating of the devices during use, aging of the devices over time, ambient conditions, etc. FIG. 7 shows one embodiment of a HIFU system where an acoustic receiver 40 is placed in the acoustic field to sense/monitor the relative amplitude of the transmitted HIFU field. The system comprises a power supply 10 coupled to an amplifier/pulser 20 that provides an output signal to a HIFU transducer 30 for outputting acoustic energy. The acoustic receiver 40 (e.g., one or more transducers made of ceramic, PVDF, etc.) receives a portion of the acoustic field 35 produced by the HIFU transducer 30 and delivers a corresponding signal to an amplifier 50; A computer/processor 60 is coupled to the output of the amplifier 50 to process the received signal for feedback and compensation of the output of the power supply 10.

During operation, the computer/processor 60 sets the power supply 10 to a setting associated with the desired output power. The computer/processor 60 then sends an appropriate waveform to the amplifier/pulser 20 where the amplifier/pulser 20 drives the HIFU transducer 30 to output the desired acoustic waveform. The acoustic receiver 40 transforms a portion of the output waveform into an electrical waveform and transmits it to the amplifier 50 and on to the computer/processor 60. The computer/processor 60 compares the received waveform to a predetermined expected value. In one embodiment, the computer/processor compares the measured power in the received waveform to an expected power. If the output power of the power supply 10 and the amplifier/pulser 20 do not cause the transducer 30 to produce the target acoustic power, the computer/processor 60 reprograms the power supply 10 to a new value, resulting in a waveform output from the power supply 10 and amplifier/pulser 20 with an output power closer to the target value. This process is repeated (active feedback) in order to keep the value of the output power very close to the target value. In one embodiment, the feedback process is repeated continually for dynamic and continuous control of the output. In another embodiment, the feedback process is performed prior to treatment output. The transfer function for this configuration (acoustic pressure sensed/acoustic power out) can be characterized in the factory. The transfer function can also be recharacterized or verified at a customer site. Where FIG. 7 indicates digitization and digital processing of the acoustic field measurement data 35 for feedback and control, appropriate feedback and control can be achieved in the analog domain using analog signal processing 70, as shown in FIG. 8.

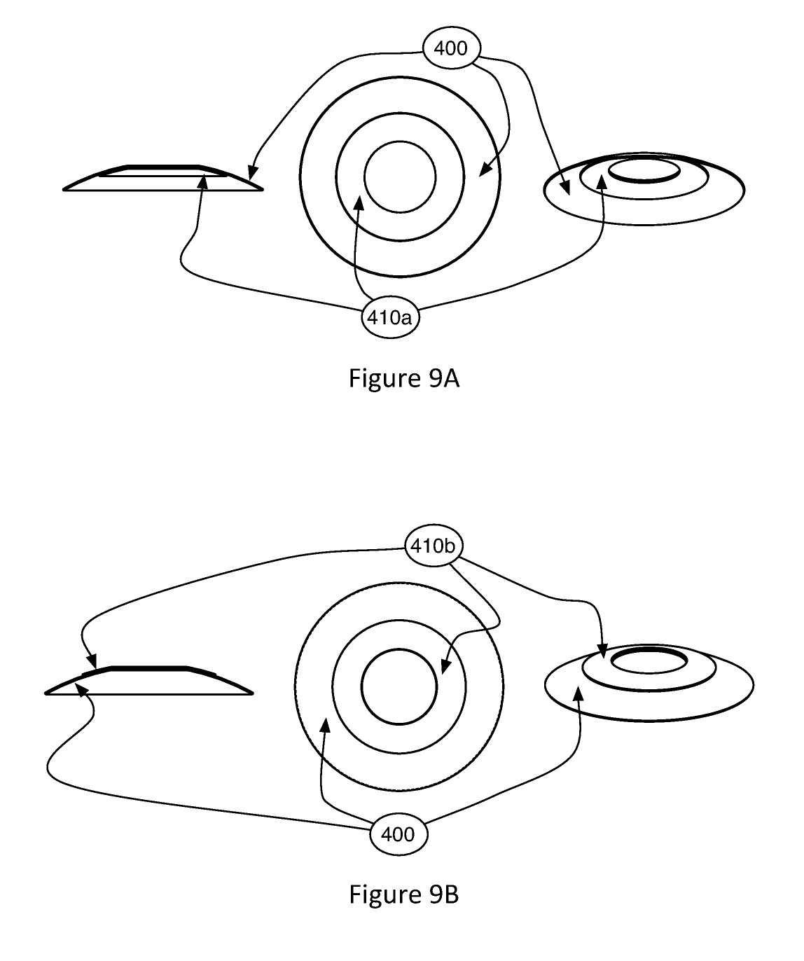

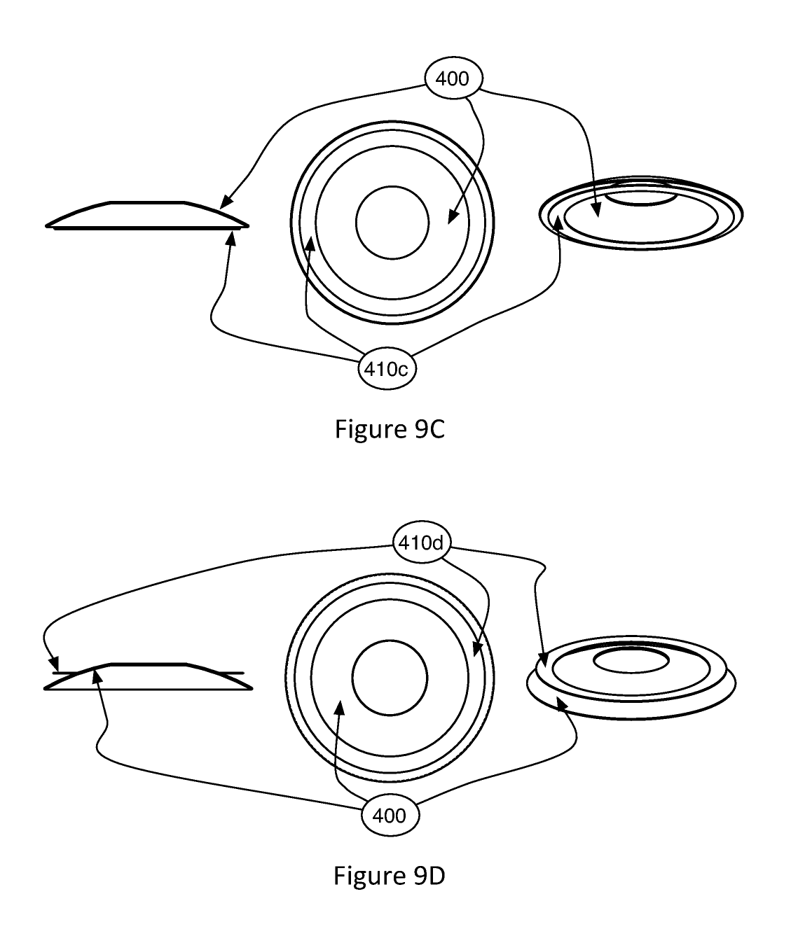

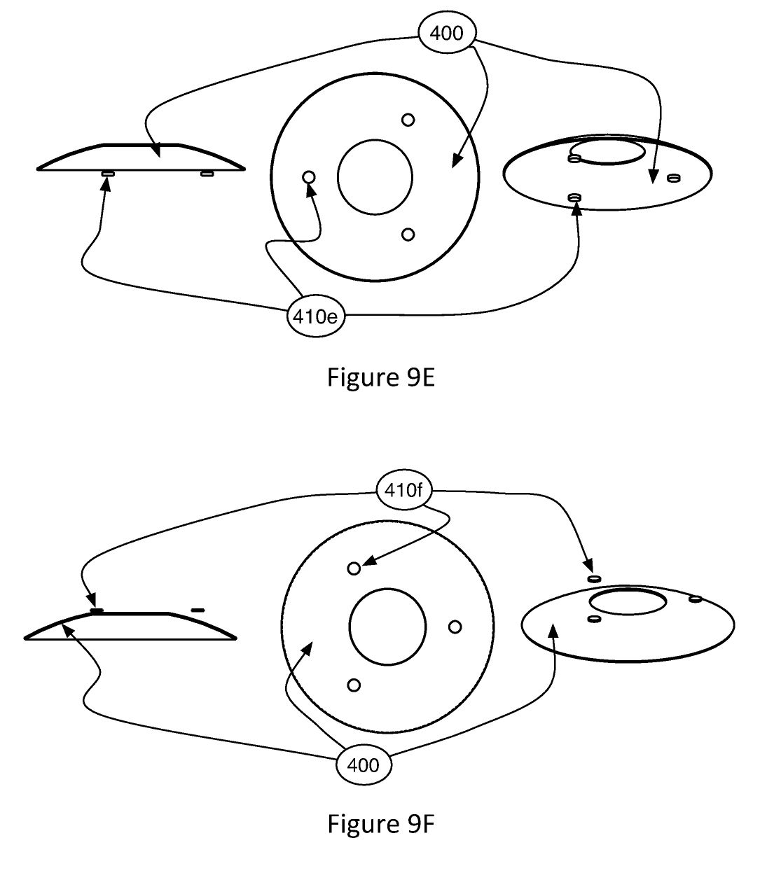

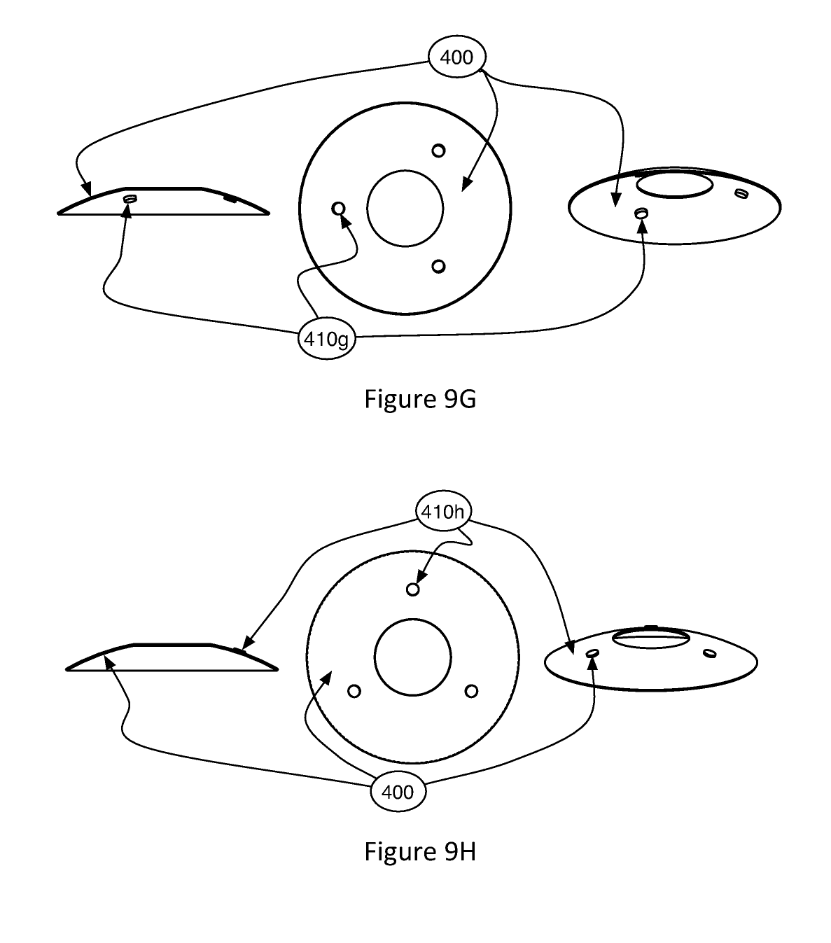

FIGS. 9A-9H show a variety of configurations of a HIFU transducer and one or more sensing transducers for sensing/monitoring the acoustic field generated by the HIFU transducer. FIGS. 9A and 9B show configurations in which receiver transducers 410a, 410b are bonded or otherwise coupled directly to the surface of the HIFU transducer 400. These receiver transducers 410a, 410b receive acoustic energy from all sectors of the HIFU transducer 400 in cases where the HIFU transducer 400 is comprised of multiple radial sectors. In the case of FIG. 9A, the receive transducer 410a would need to allow most of the transmitted acoustic energy from the HIFU transducer 400 to pass with minimal losses, to avoid device damage and/or poor efficiency. In the case of FIG. 9B, the receive transducer 410b may still require very low losses and absorption when considering heat and efficiency.

FIGS. 9C and 9D show configurations where the receive transducers 410c, 410d are still receiving acoustic energy from all sectors of a radially sectored HIFU transducer 400 or a representative annular ring of a single element HIFU transducer 400. For this configuration, the flat receive transducers 410c, 410d are of a simpler construction when compared to the transducers 410a, 410b shown in FIGS. 9A and 9B. However, flat offset receive transducers, such as 410c, 410d shown in FIGS. 9C and 9D are challenged with receiving acoustic signals from multiple paths, that is from different parts of the HIFU transducer surface 400, when compared to the receive transducers 410a, 410b that are directly coupled to the HIFU transducer 400. The receive transducer 410c may be mounted to the transducer assembly or another part of a HIFU applicator such as a patient interface membrane. In such case, a PVDF technology may be more appropriate than a ceramic device for the transducer. Receive transducer 410d may be constructed of a variety of materials and technologies, since it is not in the direct path of the treatment acoustic energy.

FIGS. 9E and 9F show one or more small receive transducers 410e, 410f offset from the surface of the HIFU transducer 400. In cases where the HIFU transducer is comprised of 2 or more radial sectors, the number of receive transducers 410e, 410f could equal the number of sectors the HIFU transducer 400 such that the acoustic energy is sensed from each of the HIFU transducer sectors. The size of the receive transducers 410e, 410f may be small relative to the transmitted wavelength so as to minimize the cancellation of the acoustic field across the receive transducer 410e, 410f.

FIGS. 9G and 9H show small receive transducers 410g 410h laminated or otherwise directly coupled to the HIFU transducer 400. This configuration may be preferred over other configurations since the receivers 410g, 410h are directly coupled to the transmit transducer, thereby eliminating multipath cancellations across the receive transducers 410g, 410h. The configurations shown in FIGS. 9G and 9H also minimize the effect on the transmitted acoustic field due to their small size. In addition, the manufacturability of these devices may be less challenging than the larger ring transducers 410a, 410b.

One challenge of the configuration shown in FIGS. 9G and 9H may be related to the lower sensitivity of the small transducers 410g, 410h when compared to the potentially larger surface areas of transducers 410a, 410b. Data may be received from a configuration where the receive transducers are positioned to receive acoustic signals from specific elements of a HIFU transducer array 400. It should be obvious to one skilled in the art, that if a HIFU transducer 400 were constructed of annular rings, then the receiver transducers 410e, 410f, 410g, 410h could be positioned radially to receive the acoustic power from the individual annular rings of the HIFU transducer 400.

In some embodiments, such as the configurations with the receive transducer are positioned behind the HIFU transducer 400, the receive transducers may be constructed of any acoustic-to-electrical transfer device, such as a piezoceramic transducer or Polyvinylidene Fluoride (PVDF) transducer. In cases where the receive transducers are in the HIFU field (e.g., configurations with the receive transducer is positioned in front of the HIFU transducer), an acoustically “transparent” material such as a PVDF transducer would be more appropriate.

In addition, one could use a mechanical property such as heating of a sensor within the acoustic field. Although a heat transfer configuration may not be a preferred embodiment, a heat transfer characteristic can be determined in the factory, relating the output of a thermoelectric transducer embedded in the HIFU transducer assembly. The thermoelectric transducer may be a thermistor embedded in the backing of the HIFU transducer with a characterized heat transfer path.

While embodiments of systems and methods have been illustrated and described in the foregoing description, it will be appreciated that various changes can be made therein without departing from the spirit and scope of the present disclosure. In addition, computer-executable instructions that cause one or more computing devices to perform processes as described herein may be stored in a non-transitory, computer-readable medium accessible to one or more computing devices. It should also be understood that rearrangement of structure or steps in the devices or processes described herein that yield similar results are considered within the scope of the present disclosure. Accordingly, the scope of the present disclosure is not constrained by the precise forms that are illustrated for purposes of exemplifying embodiments of the disclosed subject matter.

The embodiments of the invention in which an exclusive property or privilege is claimed are defined as follows:

1. A method of controlling an acoustic output from a HIFU transducer, comprising:
providing an electronic signal to a HIFU transducer to cause the HIFU transducer to output a waveform having acoustic energy;
sensing the acoustic energy of the waveform using one or more receive transducers positioned with respect to an acoustic field of the HIFU transducer;
comparing the sensed acoustic energy of the waveform to an expected value that is correlated with an intended acoustic energy; and
adjusting a control of the electronic signal to cause the HIFU transducer to output a waveform having the intended acoustic energy.

2. The method of claim 1, wherein sensing the acoustic energy of the waveform includes attaching the one or more receive transducers to a front surface of the HIFU transducer.

3. The method of claim 1, wherein sensing the acoustic energy of the waveform includes attaching the one or more receive transducers to a back surface of the HIFU transducer.

4. The method of claim 1, wherein sensing the acoustic energy of the waveform includes positioning the one or more receive transducers offset from a front surface of the HIFU transducer.

5. The method of claim 1, wherein sensing the acoustic energy of the waveform includes positioning the one or more receive transducers offset from a back surface of the HIFU transducer.

6. The method of claim 1, wherein sensing the acoustic energy of the waveform includes positioning the one or more receive transducers to individually sense a portion of the acoustic field.

7. The method of claim 1, further comprising sensing a temperature that results from acoustic energy in the acoustic field, and based on a sensed temperature, adjusting a control of the electronic signal that is provided to the HIFU transducer.

8. A system for controlling an acoustic output from a HIFU transducer, comprising:
a pulser configured to provide an electronic signal to a HIFU transducer that causes the HIFU transducer to output a waveform having acoustic energy;
one or more receive transducers positioned with respect to an acoustic field of the HIFU transducer to sense the acoustic energy of the waveform; and
a processor configured to receive a signal representative of the acoustic energy sensed by the one or more receive transducers and compare the sensed acoustic energy to an expected value that is correlated with an intended acoustic energy,
wherein the processor is further configured to adjust a control of the electronic signal to cause the HIFU transducer to output a waveform having the intended acoustic energy.

9. The system of claim 8, wherein the one or more receive transducers are attached to a front surface of the HIFU transducer.

10. The system of claim 8, wherein the one or more receive transducers are attached to a back surface of the HIFU transducer.

11. The system of claim 8, wherein the one or more receive transducers are positioned offset from a front surface of the HIFU transducer.

12. The system of claim 8, wherein the one or more receive transducers are positioned offset from a back surface of the HIFU transducer.

13. The system of claim 8, wherein a receive transducer is positioned to individually sense a portion of the acoustic field.

14. The system of claim 8, wherein a receive transducer is configured to sense a temperature that results from acoustic energy in the acoustic field, and wherein the processor is configured to adjust the control of the electronic signal provided to the HIFU transducer based on the sensed temperature.

15. The system of claim 8, further comprising:
a tuning network coupled between the pulser and the HIFU transducer, wherein the tuning network receives the electronic signal from the pulser and provides the electronic signal to the HIFU transducer with an adjusted output impedance; and
one or more circuit elements configured to sense a voltage and/or current of the electronic signal provided to the HIFU transducer,
wherein the processor is in communication with the one or more circuit elements, and wherein the processor is configured to receive the sensed voltage and/or current and adjust the tuning network to provide the electronic signal to the HIFU transducer with the adjusted output impedance.

16. A system for controlling an acoustic output from a HIFU transducer, comprising:
a pulser configured to provide an electronic signal that causes a HIFU transducer to output a waveform having acoustic energy;
a tuning network coupled between the pulser and the HIFU transducer, wherein the tuning network receives the electronic signal from the pulser and provides the electronic signal to the HIFU transducer with an adjusted output impedance;
one or more circuit elements configured to sense a voltage and/or current of the electronic signal provided to the HIFU transducer; and
a processor in communication with the one or more circuit elements and the tuning network, wherein the processor is configured to receive the sensed voltage and/or current and adjust the tuning network to provide the electronic signal to the HIFU transducer with the adjusted output impedance.

17. The system of claim 16, wherein the tuning network is adjusted to maximize power transfer from the pulser to the HIFU transducer.

18. The system of claim 16, wherein the tuning network is dynamically adjusted to reduce output power.

19. The system of claim 16, wherein the tuning network is adjusted to shift the output impedance of the electronic signal provided to the HIFU transducer to dynamically adjust a harmonic of the output waveform or other resonant frequency of the HIFU transducer.

20. The system of claim 16, wherein the processor is configured to adjust the tuning network so that the output impedance of the tuning network causes the HIFU transducer to output a waveform having an expected acoustic energy.

21. The system of claim 16, wherein the processor is further configured to adjust the electronic signal provided by the pulser to cause the HIFU transducer to output a waveform with a desired output power level, wherein the processor is configured to access a predetermined table of control values in which the control values correlate desired output power levels with an elapsed amount of time of output from the HIFU transducer, and based on (1) a difference between the acoustic energy output by the HIFU transducer and an expected acoustic energy and (2) as a measure of time of output from the HIFU transducer, the processor identifies a control value in the table that adjusts the electronic signal provided by the pulser and produces a HIFU waveform with the desired output power level.

22. The system of claim 21, wherein the control values in the table of control values are further usable by the processor to adjust the tuning provided by the tuning network as a function of the elapsed time of output by the HIFU transducer.
